(19) United States
(12) Patent Application Publication
(10) Pub. No.: US 2024/0215557 A1
(43) Pub. Date: Jul. 4, 2024

(54) FISHING INFORMATION PROCESSING SYSTEM, FISHING REEL, FISHING ROD, AND FISHING INFORMATION PROCESSING PROGRAM

(71) Applicant: Shimano Inc., Osaka (JP)

(72) Inventors: Shunsuke KUSANAGI, Osaka (JP); Akira NIITSUMA, Osaka (JP); Satoshi IKEBUKURO, Osaka (JP)

(21) Appl. No.: 18/367,290

(22) Filed: Sep. 12, 2023

(30) Foreign Application Priority Data
Dec. 28, 2022 (JP) 2022-211954

(51) Int. Cl. A01K 87/00; A01K 89/015

(52) U.S. Cl. CPC A01K 87/007; A01K 89/0178; A01K 97/125

(57) ABSTRACT

A fishing information processing system includes an acquisition unit that acquires prescribed fishing information, an information accumulation controller that accumulates the prescribed information acquired by the acquisition unit as accumulated information, an estimation unit that estimates optimum conditions related to a fishing trip based on the accumulated information accumulated by the information accumulation controller, and a provision unit that provides the optimum conditions estimated by the estimation unit to a user.

### CROSS-REFERENCE TO RELATED APPLICATIONS

This application claims priority to Japanese Patent Application No. 2022-211954, filed on Dec. 28, 2022. The entire disclosure of Japanese Patent Application No. 2022-211954 are hereby incorporated by reference.

### BACKGROUND

### Technical Field

The present disclosure relates to a fishing information processing system, a fishing reel, a fishing rod, and a fishing information processing program.

### Background Information

A fishing reel is known that can record information, such as line length, handle speed, and position, in accordance with a user operation to record an event that occurs during actual fishing, such as a fish being pulled in, a fish being hooked, or a hook becoming snagged (for example, see Japanese Laid-Open Patent Application No. 2022-038636).

### SUMMARY

It has been determined that it is desirable that fishing information that is obtained should be used effectively, so that the user can achieve good fishing results, avoid problems in connection with fishing, etc.

In consideration of the problem described above, an object of the present disclosure is to provide subject matter that enables effective use of fishing information.

A first aspect of the present disclosure that solves the problem described above is a fishing information processing system, comprising an acquisition unit that acquires prescribed fishing information, a determination unit that determines to occurred an event, based on the prescribed information acquired by the acquisition unit, and a first storage control unit that causes a first storage unit to store the prescribed information, from a prescribed time before the time that it is determined by the determination unit that an event has occurred, as event information.

A second aspect of the present disclosure that solves the problem described above is a fishing information processing system, comprising an acquisition unit that acquires prescribed fishing information, an information accumulation controller that causes a storage unit to accumulate the prescribed information acquired by the acquisition unit as accumulated information, an estimation unit that estimates optimum conditions related to a fishing trip based on the accumulated information accumulated by the information accumulation controller, and a provision unit that provides the optimum conditions estimated by the estimation unit to a user.

By the configuration described above, it is possible to estimate conditions (optimum conditions) that are optimal for prescribed matters related to fishing and to provide the estimated optimum conditions to a user. Fishing information that is obtained can thus be used effectively.

A third aspect of the present disclosure is the fishing information processing system according to the second aspect, further comprising a determination unit that determines an event occurred, based on accumulated information accumulated by the information accumulation controller, and a storage control unit that causes a storage unit to store accumulated information corresponding to the occurrence of an event determined by the determination unit as event information, wherein the estimation unit updates the optimum conditions based on the event information stored in the storage unit.

By the configuration described above, it is possible to provide optimum conditions corresponding to an event that occurs in relation to fishing.

A fourth aspect of the present disclosure is the fishing information processing system according to the second or third aspect, wherein the provision unit can provide the optimum conditions and/or information based on the accumulated information to devices corresponding to other users.

By the configuration described above, it is possible to provide optimum conditions corresponding to one user or accumulated information used to estimate the optimum conditions to other users.

A fifth aspect of the present disclosure is the fishing information processing system according to any one of the second to fourth aspects, wherein the accumulated information can be reel information related to a fishing reel.

By the configuration described above, it is possible to estimate optimum conditions using information related to the fishing reel.

A sixth aspect of the present disclosure is the fishing information processing system according to the fifth aspect, wherein the estimation unit can estimate, based on the reel information, optimum reel conditions, which are the optimum conditions related to the fishing reel.

By the configuration described above, it is possible to estimate the optimum conditions (optimum reel conditions) related to the fishing reel.

A seventh aspect of the present disclosure is the fishing information processing system according to the fifth aspect, further comprising a setting unit for setting prescribed parameters to be set in the fishing reel based on at least the optimum reel conditions.

By the configuration described above, the prescribed parameters in the fishing reel can be set based on the optimum reel conditions obtained by estimation.

An eighth aspect of the present disclosure is the fishing information processing system according to the sixth of seventh, wherein the estimation unit can update the optimum reel conditions based on the accumulated information.

By the configuration described above, it is possible to update the optimum reel conditions in accordance with changes in the state of accumulation of the accumulated information, for example.

A ninth aspect of the present disclosure is the fishing information processing system according to any one of the second to eighth aspects, wherein the accumulated information can be rod information related to a fishing rod.

By the configuration described above, it is possible to estimate optimum conditions using information related to the fishing rod.

A tenth aspect of the present disclosure is the fishing information processing system according to any one of the second through eighth aspects, wherein the estimation unit can estimate optimum fishing rod conditions, which are the optimum conditions related to the fishing rod, based on the rod information.

By the configuration described above, it is possible to estimate the optimum conditions (optimum fishing rod conditions) related to the fishing rod.

An eleventh aspect of the present disclosure is the fishing information processing system according to the tenth aspect, wherein the estimation unit can update the optimum fishing rod conditions based on the accumulated information.

By the configuration described above, it is possible to update the optimum fishing rod conditions in accordance with changes in the state of accumulation of the accumulated information, for example.

A twelfth aspect of the present disclosure is the fishing information processing system according to any one of the second to eleventh aspects, wherein the accumulated information can be fishing trip-related information related to a fishing trip.

By the configuration described above, it is possible to estimate the optimum conditions using information related to a fishing trip.

A thirteenth aspect of the present disclosure is the fishing information processing system according to the twelfth aspect, wherein the estimation unit can estimate optimum fishing trip conditions related to a fishing trip based on fishing trip-related information.

By the configuration described above, it is possible to estimate optimum conditions (optimum fishing trip conditions) related to a fishing trip.

A fourteenth aspect of the present disclosure is the fishing information processing system according to the thirteenth aspect, wherein the estimation unit can update the optimum fishing trip conditions based on the accumulated information.

By the configuration described above, it is possible to update the optimum fishing trip conditions in accordance with changes in the state of accumulation of the accumulated information, for example.

A fifteenth aspect of the present disclosure is a fishing reel equipped with the fishing information processing system according to any one of the second to the fourteenth aspects.

A sixteenth aspect of the present disclosure is a fishing rod equipped with the fishing information processing system according to any one of the second to fourteenth.

A seventeenth aspect of the present disclosure is the fishing information processing program for causing a computer to function as the fishing information processing system according to any one of the second to the fourteenth aspects.

By the present disclosure, it is possible to achieve the effect that information related to an event that occurred at the time of actual fishing can be stored accurately.

### BRIEF DESCRIPTION OF THE DRAWINGS

FIG. 1 is an example of the overall configuration of the fishing information processing system according to a first embodiment.

FIG. 2 is an example of the external appearance of the fishing reel as an electric reel according to the first embodiment.

FIG. 3 is an example of the external appearance of the fishing reel as an electric reel according to the first embodiment.

FIG. 4 is a diagram showing an example of the functional configuration of the fishing reel as an electric reel according to the first embodiment.

FIG. 5 is a diagram showing an example of the functional configuration of a user terminal in the first embodiment.

FIG. 6 is a diagram showing an example of the functional configuration of a fishing-related support server according to the first embodiment.

FIG. 7 is a flowchart showing an example of the processing procedure executed by the fishing reel according to the first embodiment in relation to the storage of event information.

FIG. 8 is a flowchart showing an example of the processing procedure executed by the fishing reel, the user terminal, and the fishing-related support server according to the first embodiment in relation to provision of optimum conditions.

FIG. 9 is a diagram showing an example of the external appearance of the fishing reel as a dual-bearing reel according to a fourth embodiment.

FIG. 10 is a diagram showing an example of the external appearance of the fishing reel as a dual-bearing reel according to the fourth embodiment.

FIG. 11 is a diagram showing an example of the functional configuration of the circuit unit part according to the fourth embodiment.

FIG. 12 is a flowchart showing an example of the processing procedure executed by the fishing reel, the user terminal, and the fishing-related support server according to the fourth embodiment in relation to setting the braking control parameters based on optimum conditions.

FIG. 13 is a diagram showing an example of the external appearance of a fishing reel as a spinning reel according to a fifth embodiment.

### DETAILED DESCRIPTION OF EMBODIMENTS

### First Embodiment

### Configuration Example of the Fishing Information Processing System

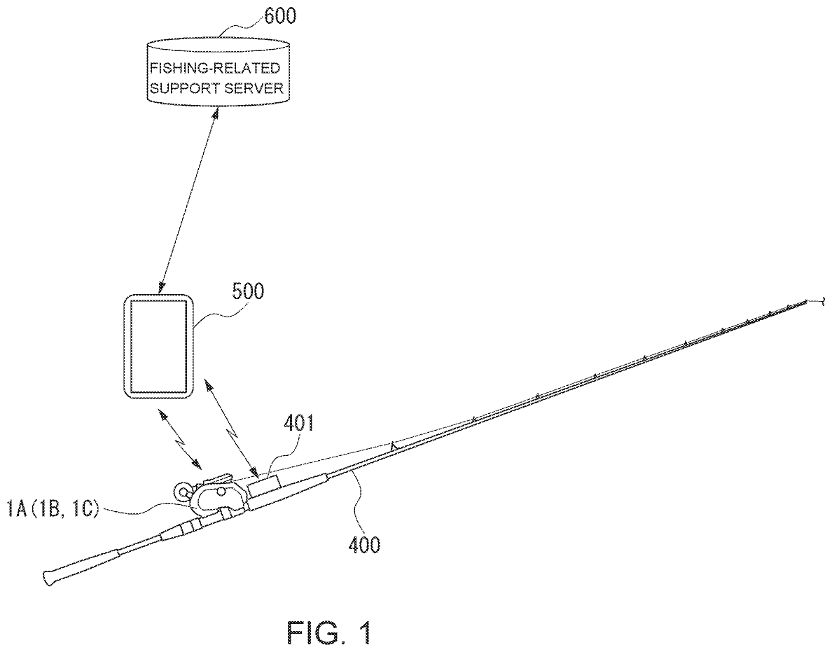

FIG. 1 shows an example of the overall configuration of a fishing information processing system according to the present embodiment. The fishing information processing system of FIG. 1 comprises a fishing reel 1A, a fishing rod 400 (one example of a fishing rod), a user terminal 500, and a fishing-related support server 600.

The fishing reel 1A is mounted on the fishing rod 400 for use. In the FIG. 1, a fishing rod sensor unit 401 provided on the fishing rod 400 corresponds to a second embodiment, so that its description is omitted here.

The user terminal 500 is used by a user who is an angler. The user terminal 500 can be, for example, a smartphone, a tablet terminal, or the like.

The fishing reel 1A is communicatively connected to the user terminal 500. Communication between the user terminal 500 and the fishing reel 1A can be wireless or wired, but wireless communication will be described below as an example. Further, the wireless communication method between the user terminal 500 and the fishing reel 1A is not particularly limited and can be short-range wireless communication, such as BLE (Bluetooth Low Energy), NFC (Near Field Communication), etc.

The fishing-related support server 600 is communicatively connected with the user terminal 500 via a network. The fishing-related support server 600 provides useful fishing information to the user, as described further below. The provision of information can be realized by transmitting the information from the fishing-related support server 600 to the user terminal 500 and outputting the transmitted information from the user terminal 500 as sound or visually on a display.

### Example Structure of the Fishing Reel

In the present embodiment, an embodiment in which the fishing reel 1A is an electric reel is used as an example.

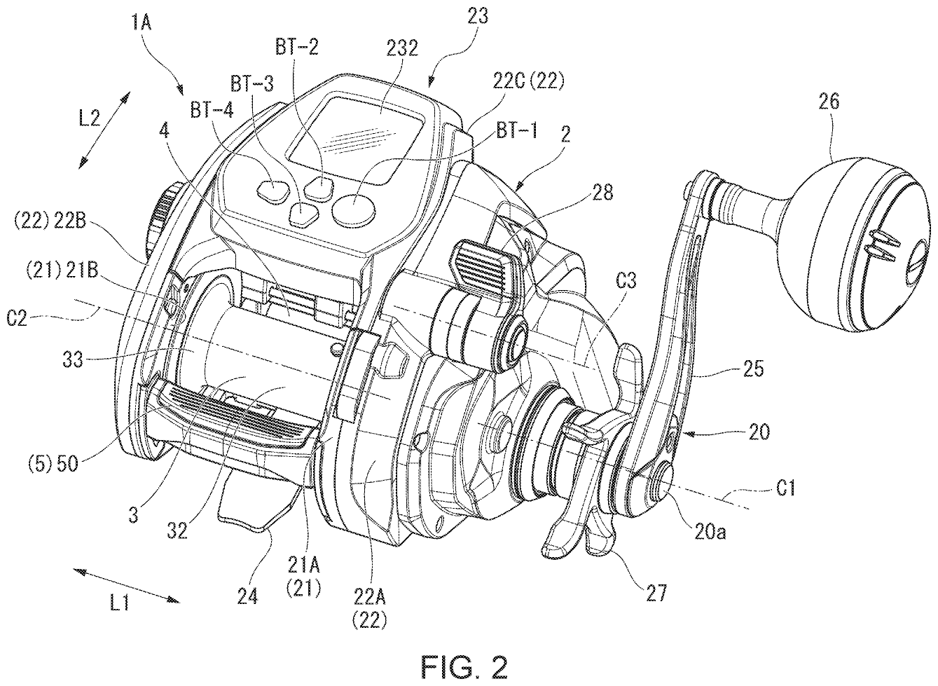

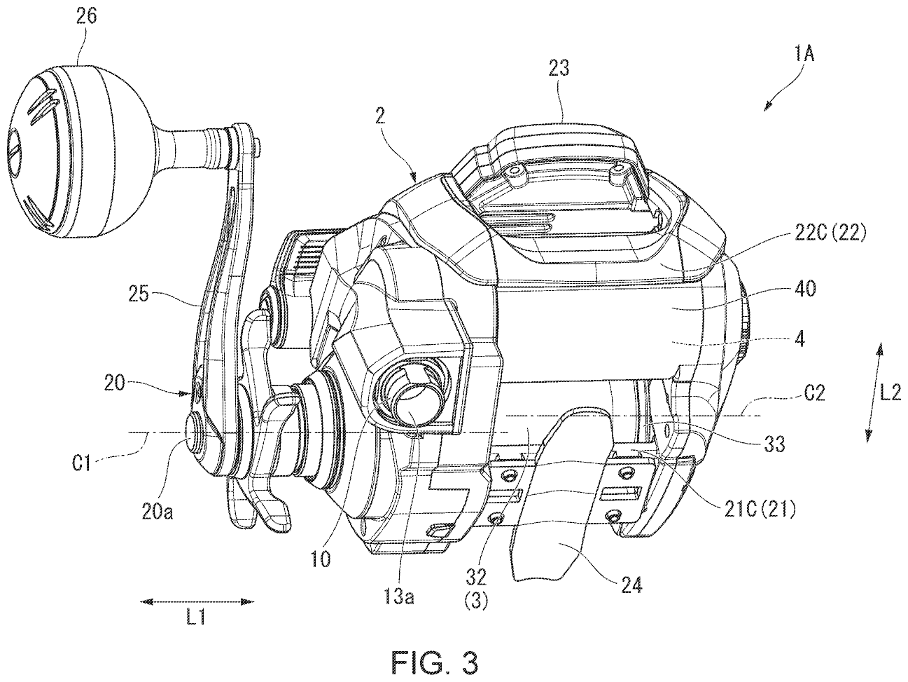

FIGS. 2 and 3 show an example of the external appearance of the fishing reel 1A as an electric reel. The fishing reel 1A shown in FIGS. 2 and 3 is driven by the electric power supplied from an external power source and also has an internal power source for use as a hand-wound dual-bearing reel.

The fishing reel 1A comprises a reel body 2 that can be mounted on the fishing rod, a handle 20 that is attached to the reel body 2 so as to be rotatable about a handle axis C1, a spool 3 rotatable about a spool axis C2 that is parallel to handle axis C1 with respect to the reel body 2 and around which a fishing line, not shown, is wound, and a motor 4 disposed in the reel body 2 that transmits rotational drive force to the spool 3.

The fishing reel 1A also has a clutch mechanism 5. The clutch mechanism 5 is a mechanical part configured to be able to switch between a connected (clutch-on) state in which the spool 3 and the handle 20 are connected and a disconnected (clutch-off) state in which the spool 3 and the handle 20 are disconnected. The clutch can be switched between the clutch-on state and the clutch-off state by operation of a clutch operating member 50 by an angler as the user.

Here, in the present embodiment, the handle axis C1 and the spool axis C2 are parallel, in the direction necessarily defined as the left-right direction L1; the direction that is orthogonal to the left-right direction L1 and in which the fishing line is wound around the spool 3 and is paid out is defined as the front-rear direction L2. Further, the direction in which the fishing line is paid out from the spool 3 in the front-rear direction L2 is defined as the front, the opposite direction is defined as the rear, and left and right are defined in relation to the fishing reel 1A as seen from the rear.

FIG. 2 is a perspective view of the fishing reel 1A as seen obliquely from above and the rear, and FIG. 3 is a perspective view of the fishing reel 1A as seen obliquely from below and the front.

The reel body 2 comprises a body frame 21, a cover 22 that covers a portion of the body frame 21, and a display operation panel part 23 positioned above the body frame 21.

The body frame 21 is an integrally formed member made of synthetic resin or metal, for example. Sandwiching the spool 3 in the left-right direction L1, the body frame 21 has a right-side plate 21A on the handle 20 side and a left-side plate 21B opposite the right-side plate 21A, and a plurality of connecting members 21C that connect the right-side plate 21A and the left-side plate 21B.

The right-side plate 21A and the left-side plate 21B are separated from each other in the left-right direction L1. Further, support portions that support the spool 3 and the motor 4, and a rotary drive mechanism such as the clutch mechanism 5, are disposed on each of the side plates 21A, 21B.

The ends of a rotary shaft (not shown) of the spool 3 are supported and attached to the right-side plate 21A and the left-side plate 21B so as to be freely rotatable. One of the connecting members 21C is fitted with a fishing rod mounting portion 24 for attachment to the fishing rod at approximately the central portion in the left-right direction L1.

The cover 22 includes a right-side cover 22A, a left-side cover 22B, and a front cover 22C. The right-side cover 22A covers the right-side plate 21A with a prescribed housing space therebetween, and is, for example, screwed onto the outer edge of the right-side plate 21A. The left-side cover 22B covers the left-side plate 21B with a prescribed housing space therebetween, and is, for example, screwed onto the outer edge of the left-side plate 21B. The front cover 22C covers the front portion of the body frame 21.

Further, although not shown, a connector for connecting a power supply cable from the outside is disposed on the lower front portion of the right-side plate 21A.

The display operation panel part 23 is directed toward the angler that uses the fishing reel 1A and is the part operated by the angler (button operation in this embodiment).

The display operation panel part 23 is located between the right-side plate 21A and the left-side plate 21B. The display operation panel part 23 has a button section 231 and a display surface section 232.

The button section 231 is the section where button operations are performed by the angler. In the example shown in the figure, four buttons (operators) are arranged in the button section 231: a first button BT-1, a second button BT-2, a third button BT-3, and BT-4.

In the following description, when no specific distinction is to be made, the first button BT-1, the second button BT-2, and the third button BT-3 will be referred to as button BT.

The first button BT-1 is used in an operation in which the spool 3 is electrically rotated at a preset speed pattern.

Specifically, the first button BT-1 is normally used for temporary motor winding operation. Temporary motor winding is an operation for driving the motor 4 so that the spool 3 rotates at a preset constant speed as a speed pattern when the first button BT-1 is pressed. The rotational speed of the spool 3 during temporary motor winding can be changed by angler operation.

Further, the first button BT-1 is operated to instruct the execution of a jigging function in jigging mode. The jigging function is used to rotate the spool 3 with a preset jigging pattern as the speed pattern in response to a single pressing operation of the first button BT-1. The jigging pattern is set, for example, to achieve an operation in which the spool 3 is rotated to wind the fishing line at a prescribed speed for a set period of time, and then the rotation of the spool 3 is stopped for a set period of time.

The display surface section 232 is the section where prescribed contents are displayed in accordance with an operation of the fishing reel 1A. The display device disposed at to the display surface section 232 is not particularly limited, but can include, for example, a liquid-crystal display device, an organic EL display device, and the like.

As shown in FIGS. 2 and 3, the handle 20 has a handle arm 25 that is non-rotatably fixed to the distal end portion 20a of the handle shaft, a handle knob 26 that is mounted on one end of the handle arm 25 freely rotatable about an axis parallel to the handle axis C1, and a drag 27 disposed on the reel body 2 side.

The torque from the handle 20 is directly transmitted to the spool 3 when the clutch mechanism 5 is in the clutch-on state.

The spool 3 is freely rotatable between the right-side plate 21A and the left-side plate 21B by shaft bearings (not shown). The spool 3 includes a rotary shaft, not shown, a cylindrical bobbin trunk 32 that is disposed coaxially with the spool rotary shaft and that can rotate in conjunction therewith, and a flange portion 33 on each end of the bobbin trunk 32 whose diameter expands radially outwardly.

The spool 3 is rotationally driven by the motor 4 via a spool drive mechanism, not shown, and is interlocked with the clutch mechanism 5 that is driven by the clutch operating member 50. The spool rotary shaft is supported by the right-side cover 22A and the left-side cover 22B via shaft bearings, so as to be freely rotatable.

The clutch mechanism 5 can be switched between the clutch-on state, in which the rotation of the handle 20 can be transmitted to the spool 3, and the clutch-off state, in which the rotation of the handle 20 cannot be transmitted to the spool 3, by operation of the clutch operating member 50. In the clutch-on position, the rotation of a pinion gear is transmitted to the spool rotary shaft, resulting in the clutch-on state, and the pinion gear and the spool rotary shaft can integrally rotate. In the clutch-off position, the rotation of the pinion gear is not transmitted to the spool rotary shaft, resulting in the clutch-off state, and the spool 3 rotates freely.

As shown in FIG. 2, the clutch operating member 50 is a part for performing an operation to switch the clutch mechanism 5 between the clutch-on state and the clutch-off state.

The clutch operating member 50 is disposed at the rear of the reel body 2, between the right-side plate 21A and the left-side plate 21B, movable toward and away from the rear of the reel body 2 with respect to the fishing rod mounting portion 24. In the present embodiment, the clutch operating member 50 is provided so as to be pivotable about the spool rotary shaft.

The spool drive mechanism drives the spool 3 to rotate in the line winding (take-up) direction. Further, a drag force is generated against the spool 3 by the drag 27 during winding, thereby preventing fishing line breakage.

The drag 27 is coaxially installed on the handle shaft between the right-side cover 22A and the handle arm 25 of the handle 20. The spool drive mechanism includes the above-described motor 4, whose rotation in the winding direction is prohibited by an anti-reverse mechanism in the form of a roller clutch, not shown, and a rotation transmission mechanism that decelerates and transmits the rotation of the motor 4 to the spool 3 or accelerates and transmits the rotation of the handle 20 to the spool 3.

As shown in FIG. 3, the motor 4 is located at the front portion of the fishing reel 1A, in a more forward position than the spool 3 (see FIG. 2) in the front portion, and is covered by a half-split-shaped motor housing body 40.

A spool drive lever 28 is configured to be rotatable about a rotational axis C3 within a certain range of rotation in accordance with a user operation. The spool drive lever 28 is an actuator with which an operation is performed to drive the spool 3 in the direction of rotation corresponding to the direction in which the fishing line is wound (take-up direction). The spool drive lever 28 is configured to change the rotational speed of the spool 3 in accordance with its rotational position. For example, if the spool drive lever 28 is rotated to the rearmost position (the frontmost position from the point of view of the user who performs the operation), the spool 3 is stopped, and as the lever is rotated forward from this position, the rotational speed of the spool is made to increase in a stepwise manner. The rotational speed of the spool 3 can be configured to increase linearly, rather than in a stepwise manner, as the spool drive lever 28 is rotated forward. In the following description, the embodiment in which the speed is changed in a stepwise manner will be described as an example.

### Overview of Event Information Storage and Optimum Condition Provision

In the fishing information processing system of the present embodiment, the storage of event information and the provision of optimum conditions to the user are performed as follows.

The storage of event information is the recording of information (event information) corresponding to an event, in accordance with the occurrence of a prescribed fishing-related event, such as during actual fishing.

Further, the optimum conditions are conditions that are estimated to be optimal for obtaining useful results for the user in relation to the prescribed event. In the fishing information processing system of the present embodiment, the provision of optimum conditions is carried out such that the optimum conditions are output from the user terminal 500 as sound or visually on a display.

In the fishing information processing system according to the present embodiment, the fishing reel 1A is equipped with various sensors. The fishing reel 1A is configured to detect and measure prescribed events using the outputs of the sensors, etc., thereby acquiring prescribed information (reel information) related to the fishing reel 1A during actual fishing.

Reel information can include at least some of the following: information related to when the fishing reel 1A was used (for example, the date and time of use. Alternatively, it can be a season of a year divided into prescribed periods.), information related to the number of times that the fishing reel 1A has been used, information related to the spool 3 (for example, specification information such as the diameter of the spool), information related to a fishing line wound around the spool 3, information related to the drag settings, etc.

The reel information can also include information (reel operation information) related to the user's operation of the fishing reel 1A. For example, the reel operation information can include at least some of the following: information related to operation of the handle 20 (such as the number of revolutions (number of rotations), the rotation speed of the handle, etc.), information related to the on/off operation of the clutch mechanism (such as the number of on/off operations), information related to the operation of the drag 27 (such as information related to the drag force set by the operation), information related to the rotation of the spool 3 (such as the direction of rotation, rotation speed, the number of revolutions (number of rotations) of the spool 3, etc.).

The reel operation information can also include reel change information. The reel change information can include at least some of the following: information related to a change in tension on the fishing line wound on the spool 3, information related to a change in the fishing line in the direction of delivery (corresponding to the water depth of the lure measured based on the number of rotations of the spool 3), and information related to a change in the rotation of the handle 20.

The fishing reel 1A stores (accumulates, buffers) reel information acquired during actual fishing as accumulated information. The fishing reel 1A can buffer the accumulated information cyclically by overwriting previously accumulated information with respect to a prescribed storage capacity, for example, in the form of a ring buffer.

Further, the fishing reel 1A can store the accumulated information in such a way that divisions are indicated in the accumulated information in units of the throwing (casting) of the lure.

Specifically, for example, when the fishing reel 1A detects that the clutch mechanism 5 is off and the spool 3 is rotating freely in the line pay-out direction, the fishing reel can determine that lure casting has started and sets, according to the casting units, delimited positions for the accumulated information to be stored at the corresponding timing.

Moreover, the fishing reel 1A is configured to determine whether a prescribed event has occurred based on the outputs obtained from the sensors, etc., during actual fishing.

Examples of types of events include a fish being caught on a lure (a fish hit), a fish bite, landing a fish caught on a lure, breaking of the fishing line (a line break), snagging, and the like.

In the following description, for the sake of convenience of explanation, a case in which the event is a fish hit will be described as an example.

When the fishing reel 1A determines that an event has occurred (a fish hit), the fishing reel acquires the information accumulated for the period between the timing of the occurrence of the currently determined event and a set period of time prior thereto (information pertaining to the process leading up to the event, information pertaining to the cause of the occurrence of the event, etc.) as event information. The fishing reel 1A causes the acquired event information to be stored in a storage area different from that for the accumulated information.

In this manner, each time an event in which a fish hits occurs, the fishing reel 1A stores the corresponding event information. The event information can be stored without overwriting past information, as is the case with accumulated information.

The event information stored in the manner described above includes reel information for a period from a set period of time before the corresponding event occurs to the point in time that the event occurs. Specifically, depending on the reel information contained in the event information corresponding to a fish hit, for example, it indicates the history of the state of rotation (direction of rotation, rotation speed) of the spool 3 of the fishing reel 1A, water depth of the lure, movement (positional change) of the fishing reel 1A itself corresponding to the user's operation of the fishing rod 400 (rod action), etc., during a set period of time prior to the point at which the fish hit event occurred.

The event information described above indicates the water depth, reeling operation, rod action, etc., when a fish hits. If the water depth, rod action, fishing line reeling operation, etc., of the fishing reel 1A (the event occurrence conditions) when a fish hit are reproduced, the probability of a fish hit can be considered to increase.

Thus, the user can, for example, operate the fishing reel 1A during actual fishing to call up and display the contents of the event information stored in the past. The user can confirm the contents of the displayed event information and fish so as to reproduce the confirmed water depth, reeling speed, rod action, etc. By making it possible for the user to fish in this way, fishing results can be expected to improve, increasing the enjoyment of fishing.

In the present embodiment, the event information stored in the fishing reel 1A can also be transmitted to the user terminal 500 via communication. The transmission of event information from the fishing reel 1A to the user terminal 500 can be triggered, for example, by the establishment of a communication connection between the fishing reel 1A and the user terminal 500, or by the user's operation of an event information transmission instruction, in a state in which a communication connection between the fishing reel 1A and the user terminal 500 has been established. The user terminal 500 can store event information transmitted in this manner.

In the present embodiment, the user terminal 500 can output the contents of the event information that it has stored in response to a user operation, for example, as sound or on a display. In this case, the user can confirm what the contents of the event occurrence conditions were when a fish hit in the past at any location and on any occasion. In this manner, the user can check the conditions when the fish hit in the past (the process leading to the fish hit, the cause of the fish hit) and evaluate how to fish in future fishing trips, thereby increasing the enjoyment of fishing.

Moreover, in the fishing information processing system of the present embodiment, when transmitting optimum information, the user terminal 500 generates estimated usage information including the event information acquired from the fishing reel 1A and transmits the generated estimated usage information to the fishing-related support server 600.

The fishing-related support server 600 uses the received estimated usage information to estimate the optimum conditions corresponding to the event. For example, during an event corresponding to a fish hit, the fishing-related support server 600 uses the estimated usage information to estimate the optimum contents as the conditions under which it can be expected to make a fish hit, thereby obtaining the estimation result as the optimum condition.

At this time, the fishing-related support server 600 can use the event information corresponding to the user to whom the information is provided to estimate the optimum conditions, or the fishing-related support server can use the event information corresponding to others besides the user to whom the information is provided in addition to the event information corresponding to the user to whom the information is provided to estimate the optimum conditions.

The fishing-related support server 600 transmits the estimated optimum conditions to the user terminal 500. The user terminal 500 outputs the optimum conditions received from the fishing-related support server 600 by a display. The user terminal 500 can output the optimum conditions by sound.

For example, the optimum conditions corresponding to a fish hit can indicate the water depth of the lure, the operation of the fishing rod 400 (rod action), the winding operation of the fishing line on the fishing reel 1A, etc. The user can confirm the contents of the optimum conditions output from the user terminal 500 and fish in such a way as to reproduce the confirmed contents. By fishing in this manner, the user can expect to obtain good fishing results.

### Example of the Functional Configuration of the Fishing Reel

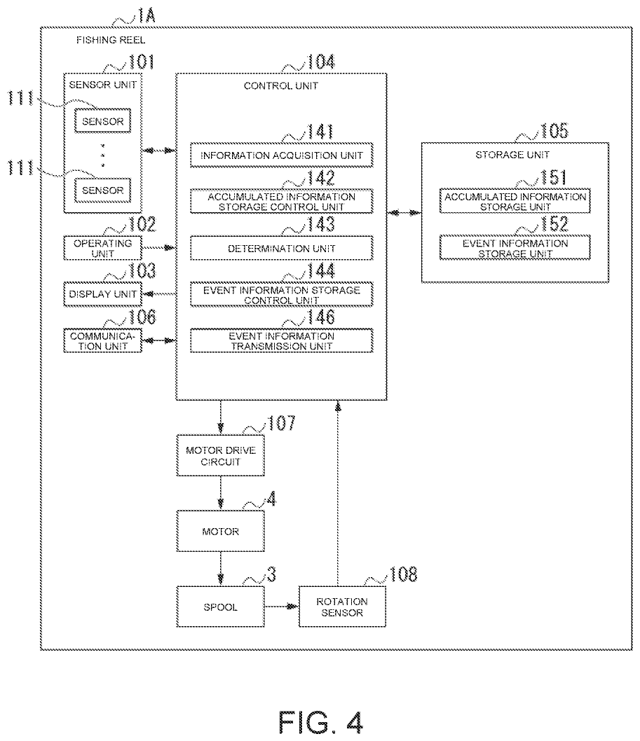

An example of the functional configuration of the fishing reel 1A as an electric reel will be described with reference to FIG. 4. In FIG. 4, the same parts as those in FIGS. 2 and 3 have been assigned the same reference symbols and descriptions thereof are omitted. The fishing reel 1 of FIG. 4 comprises a sensor unit 101, an operating unit 102, a display unit 103, a controller 104, the storage unit 105, a communication unit 106, a motor drive circuit 107, the motor 4, the spool 3, and a rotation sensor 108.

The sensor unit 101 includes one or more prescribed sensors 111 disposed on the fishing reel 1. The sensors 111 can include a sensor for detecting the movement of the fishing reel 1 itself, a sensor for detecting vibrations of the fishing reel 1, and the like. For example, angular velocity sensors, piezoelectric sensors, and the like, can be used as the sensors 111 that detect movement and vibrations of the fishing reel 1 in this manner.

The operating unit 102 includes parts of the fishing reel 1 that are operated by the user, such as buttons, handles, levers, etc. In correspondence to FIG. 2, the operating unit 102 includes the button section 231.

The display unit 103 is the part that displays in accordance with the control of the controller 104. In correspondence with FIG. 2, the display unit 203 includes the display surface section 232.

The controller 104 executes various controls in the fishing reel 1. The functions as the controller 104 are realized by a CPU (Central Processing Unit) disposed in the fishing reel 1 that executes a program.

The controller 104 includes an acquisition unit 141, an accumulated information storage control unit (controller) 142, a determination unit 143, an event information storage control unit (controller) 144, and an event information transmission unit 146.

The acquisition unit 141 acquires information to be included in the accumulated information to be stored in an accumulated information storage unit 151. The acquisition unit 141 of the present embodiment acquires reel information.

The acquisition unit 141 can acquire the time of use of the fishing reel 1A as the reel information based on the date and time indicated by a clock function of the controller 104.

Further, the acquisition unit 141 can be configured to count the number of times the fishing reel 1A has been used as the reel information by determining whether the fishing reel 1A has been used based on the output of an acceleration sensor, a vibration sensor, etc., disposed in the sensor unit 101 as the sensor 111.

Further, the acquisition unit 141 can acquire information related to the specifications, etc., of the spool 3 as the reel information, from information related to specifications, etc., of the spool 3 stored in the storage unit 105 in advance. Alternatively, the acquisition unit 141 can acquire, as the reel information, information related to specifications, etc., of the spool 3 input by user operation on the operating unit 102.

Further, regarding information related to the fishing line wound around the spool 3 as the reel information, the acquisition unit 141 can acquire information such as the type and winding length of the fishing line input by the user's operation of the operating unit 102.

Further, regarding information related to the drag settings as the reel information, the acquisition unit 141 can acquire the drag force output by the sensor 111 that is disposed in the drag 27 and that detects the drag force. Alternatively, the acquisition unit 141 can acquire, as information related to the drag settings as the reel information, the drag force measured by the controller 104 based on the detected operation of the drag 27 and the tension on the fishing line measured during interaction with a fish caught on the lure.

Further, the acquisition unit 141 can acquire information related to the operation of the handle 20, which is reel operation information included in the reel information, information related to the on/off operation of the clutch mechanism, information related to the operation of the drag 27, and information related to the rotation of the spool 3 in the following manner.

That is, the acquisition unit 141 can acquire information related to the operation of the handle 20 based on an output of the sensor 111 that detects rotation (rotational position) of the handle 20.

Further, the acquisition unit 141 can acquire information related to the on/off operation of the clutch mechanism based on an output of the sensor 111 provided to detect the on/off of the clutch mechanism.

Further, the acquisition unit 141 can acquire information related to changes in the drag force detected or measured with respect to the drag 27 and the timings of the changes, as information related to the operation of the drag 27.

Further, the acquisition unit 141 can acquire the direction of rotation and rotation speed of the spool 3 detected by the rotation sensor 108 as information related to the rotation of the spool 3, thereby acquiring the water depth of the lure measured based on the number of rotations of the spool 3 detected by the rotation sensor 108.

The accumulated information storage control unit 142 (information accumulation controller) causes the accumulated information storage unit 151 to continuously store (accumulate) the accumulated information. The accumulated information storage control unit 142 of the present embodiment causes the accumulated information storage unit 151 to store the reel information acquired by the acquisition unit and contained in the accumulated information.

Further, the accumulated information storage control unit 142 can cause the accumulated information storage unit 151 to function as a ring buffer with a prescribed storage capacity and cause the accumulated information storage unit 151 to cyclically store the accumulated information.

The determination unit 143 determines whether an event has occurred. As one specific example, the determination unit 143 can determine whether an event corresponding to a fish hit has occurred based on changes in the measured value (one example of reel change information) of the tension on the fishing line that has been unreeled from the spool 3. Further, for example, the determination unit 143 can determine that an event corresponding to a fish hit has occurred in response to determining that, from a state in which the fishing rod 400 and the fishing reel 1A are operated to attract fish, a fish has been hooked and the operation has shifted to an operation of the fishing rod 400 and the fishing reel 1A corresponding a fish hit. When it is determined that an event has occurred, the determination unit 143 is configured to identify the timing at which the event has occurred.

The event information storage control unit 144 extracts the accumulated information stored in the accumulated information storage unit 151 during a period (event information extraction period) between the time corresponding to the timing of the occurrence of the event identified by the determination unit 143 and a set period of time prior thereto.

When the accumulated information is stored in the accumulated information storage unit 151 divided into casting units, the delimited position from the previous cast can be included in the event information extraction period. In such a case, the event information storage control unit 144 can extract the accumulated information for the period from the time corresponding to the timing of the occurrence of the event to the delimited position from the previous cast.

The event information storage control unit 144 causes the event information storage unit 152 to store the extracted accumulated information as event information.

The event information transmission unit 146 transmits the event information from the communication unit 106 to the user terminal 500. The event information transmission unit 146 can be configured to transmit event information stored in the event information storage unit 152. The event information transmission unit 146 can be configured to transmit event information at every prescribed period of time or each time the storage of a prescribed number of pieces of event information in the event information storage unit 152 is completed. Alternatively, each time the event information storage control unit 144 acquires accumulated information from the accumulated information storage unit 151, the event information transmission unit 146 can acquire the accumulated information from the event information storage control unit 144 as event information and transmit the acquired event information.

The storage unit 105 stores various types of information corresponding to the fishing reel 1. The storage unit 105 includes the accumulated information storage unit 151 and the event information storage unit 152.

The accumulated information storage unit 151 stores accumulated information in accordance with the control by the accumulated information storage control unit 142.

The event information storage unit 152 stores event information in accordance with the control by the event information storage control unit 144.

The communication unit 106 supports short-range wireless communication, for example, and is communicatively connected to the user terminal 500.

The motor drive circuit 107 drives the motor 4 in accordance with the control by the controller 104. The controller 104 changes the duty ratio of the pulse width of the motor drive signal by PWM (Pulse Width Modulation) control, thereby changing the rotation speed of the motor 4.

The rotation sensor 108 detects the number of revolutions of the spool (number of rotations), the rotation speed of the spool 3, etc.

### Example of the Functional Configuration of the User Terminal

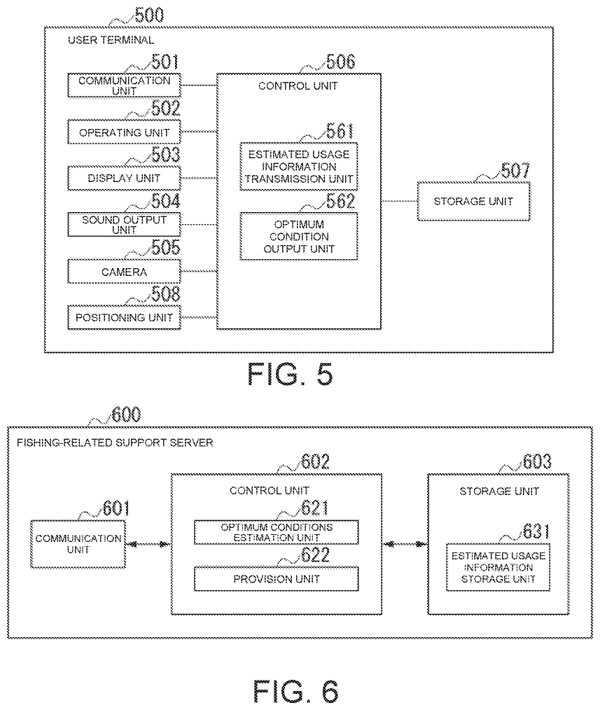

An example of the functional configuration of the user terminal 500 will be described, with reference to FIG. 5. The user terminal 500 of the figure comprises a communication unit 501, an operating unit 502, a display unit (display) 503, a sound output unit 504, a camera 505, a controller 506, a storage unit 507, and a positioning unit 508.

The communication unit 501 is a part corresponding to the communication function possessed by the user terminal 500. Specifically, the communication unit 501 supports short-range wireless communication and is connected to the fishing reel 1A, or the like within a communication range for communication. Further, the communication unit 501 supports network communication and connects to other terminals, servers, and other nodes via a network.

The operating unit 502 is a part that encompasses actuators and input devices indisposed on the user terminal 500, or input devices connected to the user terminal 500.

The display unit 503 displays in accordance with the control by the controller 506.

A touch panel with which it is possible to perform operations on a display surface on which images are displayed in the user terminal 500 can be provided as the operating unit 502 and the display unit 503.

The sound output unit 504 outputs sound in accordance with the control by the controller 506.

The camera 505 outputs captured images obtained by image capture.

The controller 506 executes various controls in the user terminal 500. The functions as the controller 104 are realized by the CPU provided in the user terminal 500 executing a program.

The controller 506 includes an estimated usage information transmission unit 561 and an optimum conditions output unit 562.

The estimated usage information transmission unit 561 generates estimated usage information including the event information acquired from the fishing reel 1A and transmits the generated estimated usage information to the fishing-related support server 600.

The optimum conditions output unit 562 outputs the optimum conditions transmitted from the fishing-related support server 600 by display, sound, etc.

The storage unit 507 stores various types of information corresponding to the user terminal 500.

The positioning unit 508 measures the location of the user terminal 500 in accordance with a GPS (Global Positioning System), or the like, and outputs position information indicating the measured location.

### Example of the Functional Configuration of the Fishing-Related Support Server

An example of the functional configuration of the fishing-related support server 600 will be described with reference to FIG. 6. The fishing-related support server 600 of the figure comprises a communication unit 601, a controller 602, and a storage unit 603.

The communication unit 601 is communicatively connected the user terminal 500 via a network.

The controller 602 executes various controls in the fishing-related support server 600. The controller 602 includes an estimation unit 621 and a provision unit 622.

The estimation unit 621 uses the estimated usage information stored in an estimated usage information storage unit 631 to estimate optimum conditions.

If an event corresponds to a fish hit, as in the present embodiment, the estimated usage information includes event information obtained in accordance with a fish hit event. As described above, the event information corresponding to a fish hit event indicates the water depth at the time of the fish hit, the rod action and operation of the fishing reel 1A (fishing line winding operation) until the fish hit, etc.

The estimation unit 621 corresponds to each event unit, for example, and uses the estimated usage information including the event information of the content described above to estimate the optimum conditions for causing fish to strike. For example, the estimation unit 621 can use a set number or more pieces of event-based estimated usage information, thereby improving the accuracy of the optimum conditions estimation. Further, the estimated usage information used by the estimation unit 621 for estimating the optimum conditions can be the estimated usage information obtained in accordance with the user to whom the optimum conditions are to be provided and/or the estimated usage information obtained corresponding to one or more other users.

The optimum conditions in this situation indicate the water depth, rod action, and the operation of the fishing reel 1A considered to be optimal for causing fish to strike.

The estimation unit 621 can store (save) the estimated optimum conditions in the storage unit 603.

The estimation unit 621 can estimate optimum conditions by performing statistical processing to calculate the mean and mode for each information item of the reel information indicated in the event-based estimated usage information.

Alternatively, the estimation unit 621 can estimate the optimum conditions using a learned model. In this embodiment, the learned model can be constructed, for example, by inputting a large number of pieces of estimated usage information corresponding to each event corresponding to a fish hit, thereby increasing the accuracy of the optimum conditions. The estimated usage information to be input to the learning device can be obtained by using information transmitted from the user terminal 500 and stored in the estimated usage information storage unit 631 or by using estimated usage information separately prepared for learning.

Further, new estimated usage information is stored in the estimated usage information storage unit 631 each time an event occurs as a result of actual fishing. That is, the collection of estimated usage information stored in the estimated usage information storage unit 631 changes over time.

Thus, the estimation unit 621 can perform re-estimation using the collection of estimated usage information stored in the estimated usage information storage unit 631 in accordance with changes in the collection of estimated usage information stored in the estimated usage information storage unit 631. In this manner, as a result of the estimation unit 621 performing the re-estimation, the optimum information can be updated to correspond to the current collection of estimated usage information stored in the estimated usage information storage unit 631. In the case that the estimation unit 621 is configured to estimate the optimum conditions using a learned model, the learned model can be retrained using the current collection of estimated usage information stored in the estimated usage information storage unit 631. The estimation unit 621 can use the retrained learned model to estimate the optimum conditions of the content updated in accordance with the current collection of estimated usage information stored in the estimated usage information storage unit 631.

The provision unit 622 transmits the optimum conditions estimated by the estimation unit 621 to the user terminal 500.

The storage unit 603 stores various types of information related to the fishing-related support server 600. The storage unit 603 includes the estimated usage information storage unit 631.

The estimated usage information storage unit 631 stores the estimated usage information transmitted from the user terminal 500.

### Example Processing Procedure

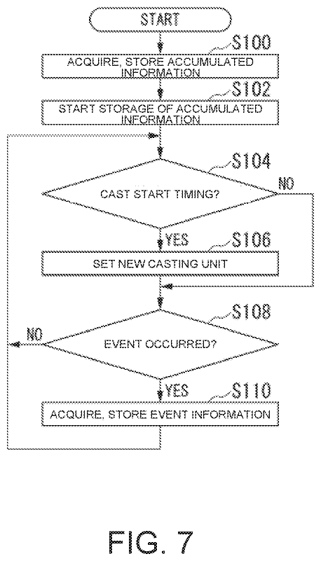

An example of the processing procedure performed by the fishing reel 1A of the present embodiment in relation to the storage of event information will be described with reference to the flowchart of FIG. 7.
Step S100: In the fishing reel 1A, the acquisition unit 141 starts the acquisition of accumulated information including reel information when the power is turned on, for example.
Step S102: The accumulated information storage control unit 142 initiates control to cause the accumulated information storage unit 151 to store the accumulated information acquired by the acquisition unit 141 in Step S100.
Step S104: After the storage of accumulated information is started in Step S102, the accumulated information storage control unit 142 determines whether a time at which casting has started has been reached.
Step S106: If it is determined in Step S104 that a time at which casting has started has been reached, the accumulated information storage control unit 142 sets, according to the casting unit, a new delimited position for the accumulated information at the time corresponding to the timing at which the casting was started.
Step S108: After the process of Step S106, or if it is determined in Step S104 that a time at which casting was started has not been reached, the determination unit 143 determines whether an event corresponding to a fish hit has occurred. If it is determined that an event has not occurred, the process returns to Step S104.
Step S110: If it is determined in Step S108 that an event has occurred, the event information storage control unit 144 acquires, from the accumulated information storage unit 151, the accumulated information during the event information extraction period, starting from the timing at which the event occurred. The event information storage control unit 144 causes the event information storage unit 152 to store the acquired accumulated information as the event information.

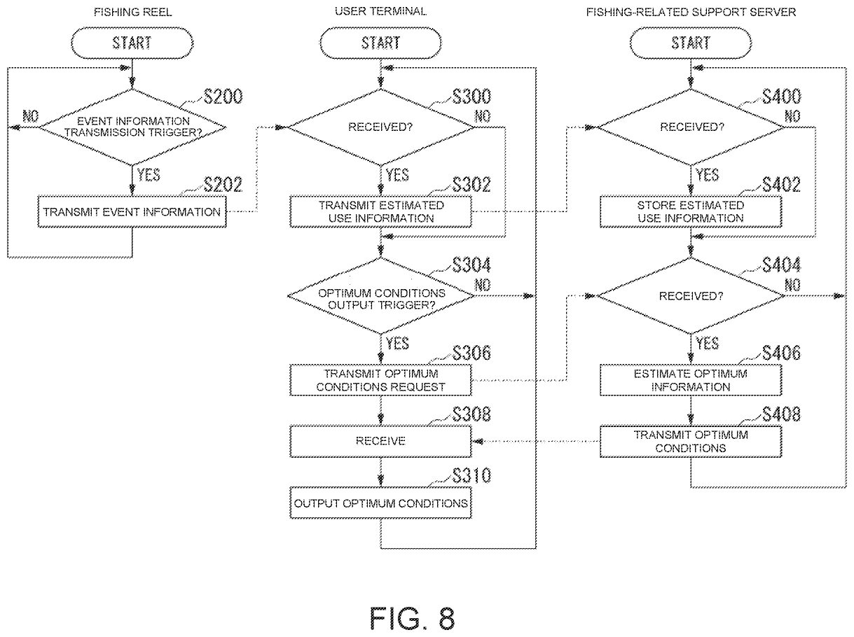

An example of the processing procedure executed by the fishing reel 1A, the user terminal 500, and the fishing-related support server 600 in relation to the provision of optimum conditions will now be described with reference to the flowchart of FIG. 8.

First, an example of the processing procedure executed by the fishing reel 1A will be described.
Step S200: In the fishing reel 1A, the event information transmission unit 146 awaits the occurrence of an event information transmission trigger.

The event information transmission trigger can be generated in response to an operation on the fishing reel 1A by the user. Further, the event information transmission trigger can be issued at each time new event information is acquired in Step S110 of FIG. 7. Further, the event information transmission trigger can be issued at prescribed time intervals. Alternatively, the event information transmission trigger can be issued at each time a prescribed number of pieces of new event information are stored in the event information storage unit 152.
Step S202: When an event information transmission trigger occurs, the event information transmission unit 146 transmits event information that has not yet been transmitted from among the event information stored in the event information storage unit 152, for example, to the user terminal 500.

An example of a processing procedure executed by the user terminal 500 will now be described.
Step S300: In the user terminal 500, the estimated usage information transmission unit 561 determines whether event information transmitted from the fishing reel 1A has been received.
Step S302: When it is determined in Step S300 that event information has been received, the estimated usage information transmission unit 561 transmits the estimated usage information to the fishing-related support server 600. The estimated usage information transmitted by the estimated usage information transmission unit 561 includes event information received in accordance with Step S300. Further, the estimated usage information can include a user identifier indicating the user of the user terminal 500 that is the transmission source. If the processing of the user terminal 500 in the figure is executed by a fishing-related support application, an application identifier that uniquely indicates the fishing-related support application can be included. The application identifier can be treated as a user identifier since it uniquely corresponds to the user terminal 500.
Step S304: After the processing of Step S302, or in the case that it is determined in Step S300 that event information has not been received, the optimum conditions output unit 562 determines whether an optimum conditions output trigger has occurred.

An optimum conditions output trigger is a trigger for issuing an instruction to output the optimum conditions by display, audio, or some other means. The optimum conditions output trigger can be issued, for example, in response to ‘a user operation on the user terminal 500. Alternatively, the optimum conditions output trigger can be issued in response to following a preset optimum conditions output schedule. Such a schedule-based optimum conditions output trigger can be managed by the fishing-related support server 600, for example, and transmitted from the fishing-related support server 600 to the user terminal 500.

If it is determined that an optimum conditions output trigger has not occurred, the process returns to Step S300.
Step S306: If it is determined in Step S304 that an optimum conditions output trigger has occurred, the optimum conditions output unit 562 transmits an optimum conditions request to the fishing-related support server 600. The optimum conditions request can include event specification information, which specifies an event corresponding to the requested optimum conditions. Further, the optimum conditions request can include the user identifier of the corresponding user.
Step S308: The optimum conditions output unit 562 receives the optimum conditions transmitted by the fishing-related support server 600 in accordance with the optimum conditions request transmitted in Step S306.
Step S310: The optimum conditions output unit 562 causes the display unit 503 or the sound output unit 504 to output the optimum conditions received in Step S308 by display or sound.

An example of a processing procedure executed by the fishing-related support server 600 will now be described.
Step S400: In the fishing-related support server 600, the estimation unit 621 determines whether the estimated usage information transmitted from the user terminal 500 in Step S302 has been received.
Step S402: If it is determined in Step S400 that the estimated usage information has been received, the estimation unit 621 causes the estimated usage information storage unit 631 to store the received estimated usage information.
Step S404: After the processing Step S402, or if it is determined in Step S400 that the estimated usage information has not been received, the estimation unit 621 determines whether an optimum conditions request transmitted in Step S306 has been received.

If it is determined that an optimum conditions request has not been received, the process returns to Step S400.
Step S406: If it is determined in Step S404 that an optimum conditions request has been received, the estimation unit 621 estimates the optimum conditions. At this time, the estimation unit 621 can estimate the optimum conditions using, from among the estimated usage information stored in the estimated usage information storage unit 631. the estimated usage information corresponding to the event specified by the event specification information included in the received optimum conditions request.
Step S408: The provision unit 622 transmits the optimum condition obtained as an estimation result of Step S406 to the user terminal 500.

### Second Embodiment

The second embodiment will now be described. As shown in FIG. 1, in the second embodiment, the fishing rod 400 includes the fishing rod sensor unit 401. The fishing rod sensor unit 401 can be pre-installed in the fishing rod 400 or can be retrofitted in the fishing rod 400.

The fishing rod sensor unit 401 includes one or more prescribed sensors and is configured to transmit detection information (rod information) output from the sensors to the fishing reel 1A via short-range wireless communication, for example. Each of the sensors disposed in the fishing rod sensor unit 401 can be provided at a prescribed portion of the fishing rod 400, as deemed appropriate, in accordance with the corresponding detection target.

Specifically, the rod information includes rod operation information indicating how the fishing rod 400 was operated by the user.

The rod operation information can include at least some of the following: information related to the speed of operation of the fishing rod 400 (for example, the casting speed during casting, the retrieval speed, etc.), information related to the vibration transmitted to the fishing rod 400 (for example, during a fish hit, at the time of reel operation, etc.), information related to the angle of the fishing rod 400 (for example, how the rod is held, the degree of bending of the rod, etc.), and information related to the orientation of the fishing rod 400 (for example, the direction of the tip of the rod).

Further, the rod operation information can include the following rod change information. The rod change information can include at least some of the following: information related to changes in the state of the fishing rod 400 (for example, changes due to the bending of the rod, changes due to damage to the rod, or the like), information related to changes in the speed of operation of the fishing rod 400 (for example, the casting speed or the pulling speed), information related to changes in vibration transmitted to the fishing rod 400 (for example, changes in vibration due to a fish hit, changes in vibration due to waves, changes in vibration due to reel operations, etc.), information related to changes in the angle of the fishing rod 400, and information related to changes in the orientation of the fishing rod 400.

The fishing rod sensor unit 401 can include an acceleration sensor, a piezoelectric sensor, and the like, at prescribed parts of the fishing rod 400 to obtain the rod operation information, as described above.

Further, the rod information can include, as information related to the usage history of the fishing rod 400, information related to time of use (for example, date and time) of the fishing reel 400 and/or information related to the number of times that the fishing rod 400 is used. The fishing rod sensor unit 401 can determine whether the fishing rod 400 is being used by an acceleration sensor, piezoelectric sensor, etc., provided at a prescribed part of the fishing rod 400 and can obtain information related to the usage history of the fishing rod 400 based on the determination result.

Further, the rod information can include, as information related to the specifications of the fishing rod 400, at least one of the following: information related to the rigidity of the fishing rod 400, information related to the condition of the fishing rod 400, the number of joints, the number and material of guides, etc., of the fishing rod 400.

Such information related to the specifications of the fishing rod 400 can be stored in the fishing rod sensor unit 401 in advance.

In the present embodiment, when event information corresponding to an event of a fish hit is to be stored, of the information elements described above, rod action, orientation and bending of the fishing rod 400 (one example of an aspect of the fishing rod) corresponding to the circumstances, such as a fish being hooked, and the rod change information that can be used to determine changes in vibration, etc., can be used as the rod information.

Specifically, the fishing rod sensor unit 401 can include an acceleration sensor that detects changes in the position of a prescribed portion of the fishing rod, as a sensor that detects changes in the orientation and bending of the fishing rod 400. Further, the fishing rod sensor unit 401 can include an acceleration sensor or a piezoelectric sensor provided at a prescribed part of the fishing rod sensor unit 401 as a sensor for detecting vibrations of the fishing rod 400.

Further, the rod information can be included in the determination of the event that the fishing rod 400 has broken, or in event information corresponding to an event in which the fishing rod 400 has broken. In this situation, for example, the event information can include the tension on the fishing line, information pertaining to the condition and rigidity of the rod in the rod information, and the like. With such event information, it is possible to ascertain the relationship between the tension on the fishing line and strength of the rod until the fishing rod breaks.

The fishing rod sensor unit 401 is communicatively connected to the fishing reel 1A. The communication between the fishing rod sensor unit 401 and the fishing reel 1A can be wireless or wired, but wireless communication will be described as an example below. The wireless communication method between the fishing rod sensor unit 401 and the fishing reel 1A is also not particularly limited, and can be, for example, BLE, NFC, or the like.

In the present embodiment, the fishing rod sensor unit 401, which is communicatively connected to the fishing reel 1A, transmits information (rod information) output by its own sensor to the fishing reel 1A.

In the fishing reel 1A, the acquisition unit 141 acquires the rod information transmitted from the fishing rod sensor unit 401 as information to be included in the accumulated information, together with the reel information. The accumulated information storage control unit 142 causes the accumulated information storage unit 151 to store the accumulated information including the reel information and the rod information.

Further, when determining whether an event has occurred, the determination unit 143 of the fishing reel 1A can use the rod information in addition to the reel information acquired by the acquisition unit 141. By using the reel information and the rod information together in this manner, it is possible to increase the accuracy of the determination of whether an event has occurred.

When the determination unit 143 has determined that an event has occurred, the event information storage control unit 144 causes the event information storage unit 152 to store the event information including the reel information and the rod information from a prescribed time before the event occurrence timing.

In the present embodiment, since rod information is included in the event information in addition to the reel information, as described above, rod information is also included in addition to the reel information in the estimated usage information that the estimation unit 621 uses to estimate the optimum conditions in the fishing-related support server 600. As a result, the optimum conditions estimated by the estimation unit 621 reflects the rod information in addition to the reel information. For example, information such as rod action in the optimum conditions as a process leading to a fish hit can be obtained more accurately by using changes in the operating speed, angle, etc., of the fishing rod in the rod information.

### Third Embodiment

The third embodiment will now be described. The present embodiment can be applied to both the first and second embodiments. In the following description, the case in which it is applied to the second embodiment will be described as an example.

In the present embodiment, the accumulated information accumulated in the accumulated information storage unit 151 also includes fishing trip-related information, in addition to the reel information and the rod information. The fishing trip-related information is information related to the user's fishing trips. Here, “fishing trip” can refer to the user's actual fishing in the past.

Fishing trip-related information can include information (fishing trip history information) related to the history of actions as part of the fishing trip. The fishing trip-related information can include at least some of the following: information related to the time of the fishing trip (for example, the fishing season, the date and time of the fishing trip, the fishing times), information related to the number of fishing trips (for example, the average number of fishing trips per year, the average number of fishing trips by month, the number of fishing trips according to specific location, etc.), and user location information (for example, GPS location information) indicating the location of the user during the fishing trip (at the time of actual fishing).

Further, the fishing trip-related information can include information pertaining to the weather during actual fishing (fishing-trip weather information). The fishing trip weather information can include at least some of the following: information pertaining to the local weather at the time of actual fishing (sunny, cloudy, rainy, etc.), information pertaining to the local temperature at the time of actual fishing, information pertaining to the local barometric pressure at the time of actual fishing, information pertaining to the local wind direction/wind force (wind velocity) at the time of actual fishing, and information pertaining to tides at the time of actual fishing.

In the present embodiment, the fishing trip-related information described above is included in the estimated usage information used for estimating the optimum conditions. For example, the fishing trip-related information can be acquired as follows.

For example, when transmitting the estimated usage information in Step S302 of FIG. 8, the estimated usage information transmission unit 561 can acquire the fishing trip timing based on the current date and time, acquire information pertaining to the number of fishing trips up to that point, and acquire, as the user location information, the location measured by the positioning unit 508 at the timing at which the event information is received in accordance with the present Step S300.

The information pertaining to the number of fishing trips can be obtained, for example, based on the number of times the user declares to a fishing trip support application installed in the user terminal 500 that the user is actually going to fish (actual fishing declaration), and then the estimated usage information transmission unit 561 obtains the information based on the number of times that an actual fishing declaration operation has been performed thus far.

Further, when transmitting the estimated usage information in Step S302, the user terminal 500 can access a prescribed weather information site that provides weather information via a network and acquire weather information (weather, temperature, barometric pressure, wind direction/wind force, tide information, etc.) corresponding to the current location and date and time.

In Step S302, the user terminal 500 generates estimated usage information including the event information (reel information, rod information) received in accordance with Step S300 and the fishing trip-related information acquired as described above, and transmits the generated estimated usage information to the fishing-related support server 600.

For example, when an event corresponding to a fish hit, such estimated usage information of the present embodiment could include, in addition to the rod action operations and the patterns of operations of the fishing reel 1A, the location, date and time (timing), and the weather conditions when the fish hit as conditions when the fish hit. If the optimum conditions are estimated using such estimated use information, conditions for causing fish to hit can be presented to the user, taking into consideration the location, date and time (timing), weather conditions, and the like.

As for the fishing trip-related information, the user terminal 500 and the fishing-related support server 600 can each acquire prescribed information items, and the respectively acquired information items are then aggregated to obtain the fishing trip-related information.

### Fourth Embodiment

The fourth embodiment will now be described. The fishing reel 1A used in the fishing information processing system of each of the embodiments described above is an electric reel. However, the fishing reel used in the fishing information processing system is not limited to an electric reel. In the fishing information processing system of the present embodiment, a dual-bearing reel (bait reel) is used as the fishing reel, as described below.

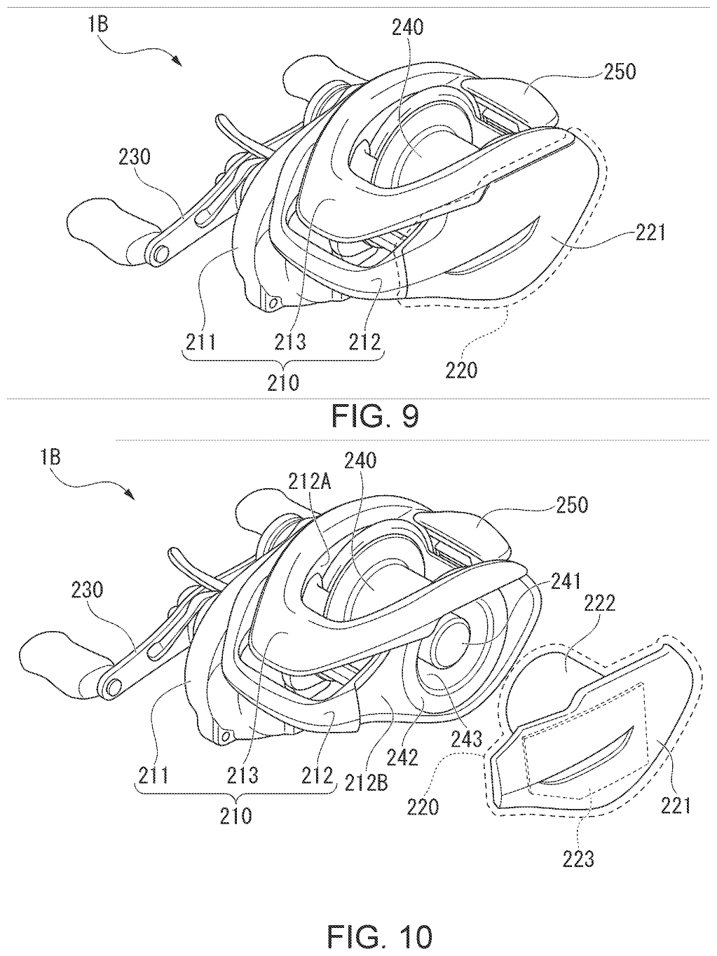

FIGS. 9 and 10 show an example of the external appearance of a fishing reel 1B as a dual-bearing reel used in the fishing information processing system of the present embodiment. FIG. 9 shows an example of the external appearance of the fishing reel 1 with a detachable unit 220 attached to a main body 10. FIG. 10 shows an example of the external appearance of the fishing reel 1B with the detachable unit 220 removed from the main body 210.

The fishing reel 1B of the same figure comprises the main body 210, a handle 230, a spool 240, and a clutch operating unit 250.

The main body 210 includes main body 210 and the detachable unit 220. The main body 210 includes a side plate part 211, a frame part 212, and a thumb rest 213.

The frame part 212 includes a handle-side frame part 212A that rotatably holds one end of a spool shaft of the spool 240 and to which a handle shaft is attached, and a hold-side frame part 212B that rotatably holds the spool 240 at the other end of the spool shaft of the spool 240.

The detachable unit 220 can be attached to/detached from the main body 210. Specifically, the detachable unit 220 is disposed on the hold-side frame part 212B, which is on the side of the main body 210 that is opposite the handle 230.

When the detachable unit 220 is mounted on the main body 210 as shown in the figure, the main body 210 and a cover 221 of the detachable unit 220 form the contours of the fishing reel 1B.

As shown in the figure, the detachable unit 220 includes a braking unit part 222 that is integrated with the rear side of the cover 221. The braking unit part 222 houses a braking member that brakes the spool 240 that rotates freely during casting. The braking unit part 222 is provided integrally with the housing of the detachable unit 220 including the cover 221.

When the detachable unit 220 is mounted on the main body 210, the braking unit part 222 is inserted into a circular spool space 243 between a spool shaft 241 and a spool periphery 242 on the side surface of the spool 240.

That is, the main body 210 rotatably holds one end of the spool shaft 241, and the detachable unit 220 rotatably holds the other end of the spool shaft 241.

A braking magnet is disposed on the spool shaft 241. The spool shaft 241 rotates together with the spool 240. When the detachable unit 220 is mounted on the main body 210 and the braking unit part 222 is inserted into the spool space 243, a brake unit in the braking unit part 222 is in a state in which a plurality of coils are arranged surrounding the outer circumference of the spool shaft 241. The plurality of coils are connected in series.

A circuit unit part 223 is housed inside the housing of the detachable unit 220.

The circuit unit part 223 includes a power supply circuit, a communication module, a braking circuit, a computer unit, etc.

The power supply circuit of the circuit unit part 223 contains a battery, for example, and outputs power from the battery to the communication module and the computer unit as a power source.

The communication module of the circuit unit part 223 has the function of communicating with an external communication device by a prescribed short-range wireless communication method. The short-range wireless communication method that the communication module supports is not particularly limited and can be BLE, NFC, etc. The communication module is operated by a power supplied from the power supply circuit.

The braking circuit in the circuit unit part 223 is composed of a circuit (braking circuit) corresponding to the braking control by the brake unit.

The braking circuit is configured to operate by the power generated in the coil of the brake unit in the braking unit part 222 in accordance with the rotation of the spool 240. Alternatively, the braking circuit can be operated by the power supplied by the power supply circuit.

The computer unit in the circuit unit part 223 executes control related to storage of accumulated information and the storage and output of event information. The computer unit can be operated by the power supplied from the power supply circuit.

In the present embodiment, the housing of the detachable unit 220 is formed to be watertight. Since the circuit unit part 223 is housed (included) in the watertight housing of the detachable unit 220, the circuit unit part 223 will not be inundated with water.

The braking control of the brake unit of the fishing reel 1B according to the present embodiment is performed as follows.

Before casting a lure, the angler releases the clutch so that the spool 240 can rotate freely. In response to the cast, the spool 240 rotates in the direction in which the wound fishing line is paid out.

As the spool 240 rotates, the coil in the brake unit generates electricity, and the generated electricity is supplied to the circuit unit part 223. The braking circuit is activated by the power thus supplied.

Memory (a storage unit) disposed in the fishing reel 1B stores parameters related to braking control (braking control parameters: for example, the braking mode and braking intensity) set by the angler. As the braking control, the braking circuit sets the duty ratio of a PWM signal with a prescribed period for the brake switch provided in the path of the current flowing through the coil of the brake unit based on the combination of the braking mode and braking intensity that have been set, thereby performing on/off control.

The braking mode is a parameter that indicates a defined pattern of temporal changes in the duty ratio of the PWM signal. In each braking mode, the duty ratio decreases with time, but each braking mode has different maximum and minimum values in the duty ratio change range and different patterns of temporally decreasing the duty ratio.

The braking intensity is a parameter that adjusts the intensity of braking under the set braking mode.

The number of braking modes and the number of braking intensities in the settings that can be selected are not particularly limited. For example, if the number of braking modes that can be selected is four and the number of braking intensities that can be selected is eight, 32 (4×8) combinations of braking modes and braking intensities are obtained. For each of the 32 combinations of braking modes and braking intensities, the pattern with which the duty ratio for braking the rotation of the spool 240 temporally changes will differ.

The braking circuit temporally changes the duty ratio of the PWM signal in accordance with the duty ratio per time determined by the set combination of the braking modes and braking intensities.

In this way, the braking circuit changes the duty ratio of the PWM signal to control the on/off time of the brake switch, thereby maintaining suitable tension on the fishing line that is paid out from the spool 240 and preventing backlash.

Although not shown in FIGS. 7 and 8, one or more sensors are disposed at prescribed positions on the fishing reel 1B. Further, although not shown in FIGS. 7 and 8, the fishing reel 1B can include actuators, such as dials, with which the braking control parameters can be changed.

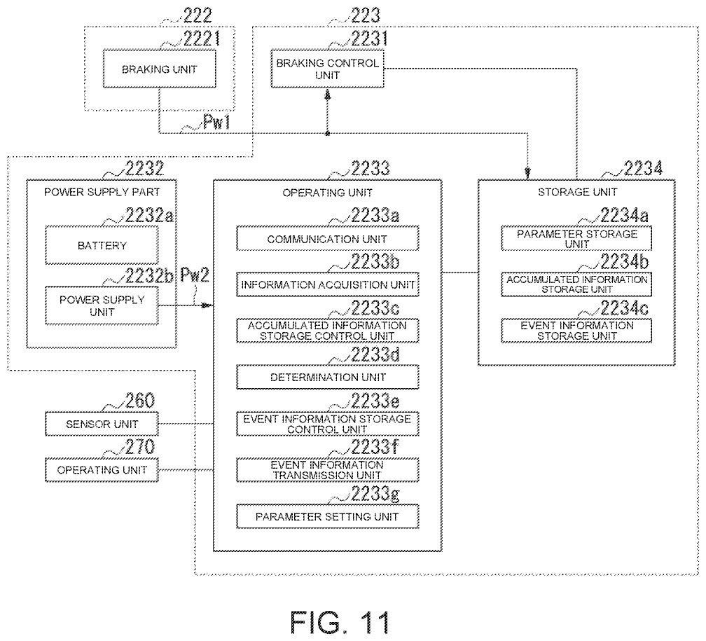

FIG. 11 shows an example of the functional configuration of the circuit unit part 223 of the fishing reel 1B. In FIG. 11, the braking unit part 222, the sensor unit 260, and the operating unit 270 are shown together.

The sensor unit 260 includes one or more prescribed sensors disposed in the fishing reel 1B. Examples of sensors disposed in the fishing reel 1B include a sensor for detecting the state of rotation (the direction of rotation, the rotation speed) of the spool 240, a sensor for detecting positional changes in the fishing reel 1B itself, and a sensor for detecting vibrations of the fishing reel 1B.

The operating unit 270 is a part that includes actuators, such as dials, that the user operates when setting the braking control parameters.

The detachable unit 220 shown in FIGS. 10 and 11 includes a braking unit 2221. The braking unit 2221 is housed in the braking unit part 222 and brakes the spool 240 during casting, in accordance with the control (PWM control) of a braking controller 2231.

The braking unit 2221 can supply the electric power generated by the internal coil in accordance with the rotation of the spool 240 during casting as a power source (spool power source Pw1) to operate the circuits, etc., respectively corresponding to the braking controller 2231 and a storage unit 2234.

Further, the detachable unit 220 includes the braking controller 2231, a power supply part 2232, an operation unit 2233, and the storage unit 2234, as functional units realized by components mounted in the circuit unit part 223.

The braking controller 2231 executes braking control. The circuit corresponding to the braking controller 2231 in the circuit unit part 223 can be operated by receiving power supplied from the spool power source Pw1. The function as the braking controller 2231 is realized, for example, by the execution of a program by a CPU installed in the circuit unit part 223.

When activated by receiving power supplied from the spool power source Pw1, the braking controller 2231 reads the braking control parameters (braking mode, braking intensity) stored as set values in a parameter storage unit 2234a that is activated by receiving the same cast-compatible supply of power. The braking controller 2231 sets the duty ratio for each time in accordance with the read out braking control parameters and controls the on/off time of the brake switch in the braking unit 2221 according to the set duty ratio, thereby braking the rotation of the spool 240.

The power supply part 2232 is configured so that a power supply unit 2232b can output, as a power source, the power output from a battery 2232a to the sensor unit 260, the operation unit 2233, the storage unit 2234, etc. The battery 2232a can be configured, for example, with a wirelessly rechargeable secondary battery.

The operation unit 2233 can be operated by receiving the power supplied from a power supply power source Pw2 from the power supply part 2232. The operation unit 2233 executes control related to the storage of accumulated information and the storage and output of event information. Further, the operation unit 2233 executes a process related to the setting of braking control parameters.

The operation unit 2233 includes a communication unit 2233a, an acquisition unit 2233b, an accumulated information storage control unit (controller) 2233c, a determination unit 2233d, an event information storage control unit (controller) 2233e, an event information transmission unit 2233f, and a parameter setting unit 2233g.

The communication unit 2233a is provided as a communication module, for example, and is communicatively connected to the user terminal 500 and the fishing rod sensor unit 401 by short-range wireless communication, such as BLE and NFC.

Since the acquisition unit 2233b, the accumulated information storage control unit 2233c, the determination unit 2233d, the event information storage control unit (controller) 2233e, and the event information transmission unit 2233f have the same functions as the acquisition unit 141, the accumulated information storage control unit 142, the determination unit 143, the event information storage control unit 144, and the event information transmission unit 146 in FIG. 4, their descriptions are omitted.

The parameter setting unit 2233g sets the braking control parameters (braking mode, braking intensity) used for braking control, in accordance with an operation performed on the operating unit 270, for example. When setting the braking control parameters, the parameter setting unit 2233g stores the set braking control parameters in the parameter storage unit 2234a.

The storage unit 234 stores prescribed information. The hardware supported by the storage unit 234 can be a storage device such as flash memory mounted on a circuit board, for example.

The storage unit 234 includes the parameter storage unit 2234a, an accumulated information storage unit 2234b, and an event information storage unit 2234c.

The parameter storage unit 2234a stores the braking control parameters set by the parameter setting unit 2233g.

The accumulated information storage unit 2234b stores accumulated information in accordance with control of the accumulated information storage control unit 2233c.

The event information storage unit 2234c stores event information in accordance with control of the event information storage control unit 2233e.

In the same manner as the fishing reel 1A of each of the embodiments described above, the fishing reel 1B as a dual-bearing reel configured in this way can store accumulated information including reel information, rod information, and fishing trip-related information, in accordance with the user's actual fishing. In the case of a dual-bearing reel, the reel information can include the set values of the braking control parameters, information related to the braking control settings, such as a history of changes to the braking control parameters.

When storing the accumulated information, the fishing reel 1B can cause the accumulated information to be stored to show divisions in casting units, in accordance with on/off of the clutch mechanism, or the like. Further, the fishing reel 1B can store event information in response to the determination of the occurrence of an event, such as a fish hit. Further, the fishing reel 1B can transmit the stored event information to the user terminal 500 and cause the user terminal 500 to display the contents of the event information.

The fishing reel 1B as a dual-bearing reel can also include a display unit; in this case, it is also possible to display the contents of the event information pertaining to the display unit of the fishing reel 1B.

In the case of a dual-bearing reel, such as the fishing reel 1B, the reel can be configured to determine whether a backlash of the fishing line (or, a state that can be regarded as a backlash of the fishing line, even if it is not actually a backlash) during casting has occurred, for example. In this case, the determination unit 2233d can determine an event occurred corresponding to a backlash based on changes in the tension on the fishing line at the time of casting. Further, the accumulated information in this case is configured to include the set values of the braking control parameters and the speed of movement of the fishing rod. With event information that is obtained from such accumulated information, the user can ascertain the relationship between the intensity of the cast, the braking control parameter settings, etc., at the time of the backlash, and then reconsider the braking control parameter settings or casting technique in order to prevent the occurrence of backlash.

Furthermore, in the fishing information processing system according to the present embodiment, it can be possible for the braking control parameters (one example of optimum reel conditions) of the fishing reel 1B, which is a dual-bearing reel, to be set based on optimal conditions of the braking control parameters estimated by the fishing-related support server 600. In this case, braking control parameters of the fishing reel 1B that are appropriate for the situation during actual fishing can be set without the user having to perform an operation to set the braking control parameters.

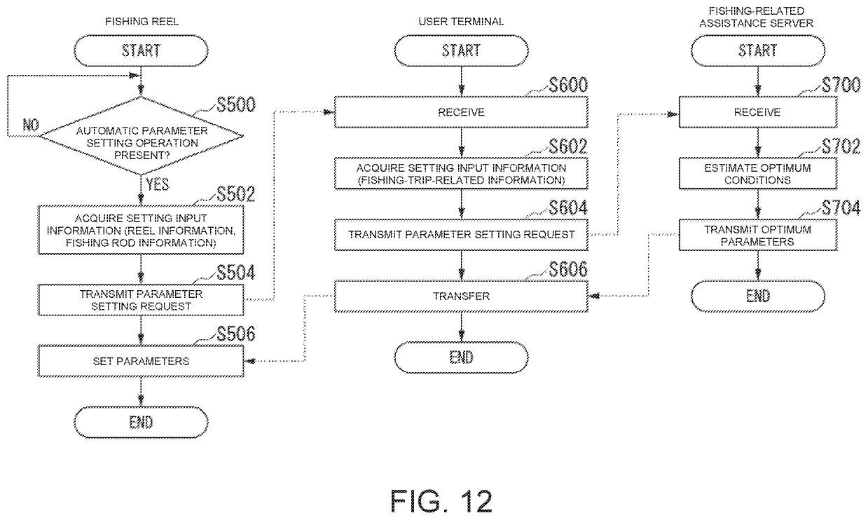

The flowchart of FIG. 12 shows an example of the processing procedure executed by the fishing reel 1B, the user terminal 500, and the fishing-related support server 600 according to the present embodiment in relation to the setting of the braking control parameters based on optimum conditions.

First, an example of the processing procedure executed by the fishing reel 1B will be described.
Step S500: In the fishing reel 1B, the parameter setting unit 2233g waits for the user to perform an automatic parameter setting operation. The automatic parameter setting operation is an operation that directs the setting (automatic parameter setting) of the braking parameters based on optimum conditions.
Step S502: In response to an automatic parameter setting operation, the acquisition unit 2233b (or the parameter setting unit 2233g) acquires the prescribed setting input information. The setting input information is information that is to be input at the time of the current automatic parameter setting, when the estimation unit 621 of the fishing-related support server 600 is made to estimate the optimum conditions corresponding to the braking control parameters.

Specifically, the setting input information can include rod information and reel information, which indicate changes in the speed of movement of the fishing rod during casting, changes in the tension on the fishing line, changes in the rotation speed of the spool, the current setting values of the braking control parameters, etc. The setting input information can also include information pertaining to the user location based on position information measured by the positioning unit 508. Further, the setting input information can include rod information or reel information indicating the direction in which the user is currently casting.
Step S504: The parameter setting unit 2233g transmits a parameter setting request to the user terminal 500. The parameter setting request includes the setting input information obtained in Step S502.

In the case that the communication unit 2233a is configured to have a communication function corresponding to a network and is capable of communicating with the fishing-related support server 600, the parameter setting unit 2233g can be configured to be capable of transmitting a parameter setting request to the fishing-related support server 600 without relaying the request through the user terminal 500.
Step S506: The parameter setting unit 2233g acquires the optimal parameters transmitted from the user terminal 500 in response to the transmission of the parameter setting request according to Step S504. The parameter setting unit 2233g sets the acquired optimal parameters as braking control parameters. Specifically, the parameter setting unit 2233g updates the braking control parameters stored in the parameter storage unit 2234a with the acquired optimal parameters.

An example of the processing procedure executed by the user terminal 500 will now be described.
Step S600: In the user terminal 500, the controller 506 receives the parameter setting request transmitted from the fishing reel 1B according to Step S504.
Step S602: The controller 506 acquires the setting input information in response to receiving the parameter setting request. In the Step S602, the controller 506 can include weather information corresponding to the current date and time and the user location information included in the received parameter setting request. In particular, with respect to casting, since wind force and the relationship between the casting direction and wind direction affect lure flight distance, backlash, etc., the weather information can include information pertaining to wind direction and wind force.
Step S604: The controller 602 transmits a parameter setting request including the setting input information included in the parameter setting request received in accordance with Step S600 and the setting input information obtained in Step S602 to the fishing-related support server 600.
Step S606: The controller 602 forwards the optimal parameters transmitted from the fishing-related support server 600 in accordance with the parameter setting request in Step S604 to the fishing reel 1B.

An example of the processing procedure executed by the fishing-related support server 600 will now be described.
Step S700: In the fishing-related support server 600, the estimation unit 621 receives the parameter setting request transmitted from the user terminal 500 according to Step S604.
Step S702: The estimation unit 621 estimates the optimum conditions using the setting input information included in the parameter setting request received in Step S700 and the estimated usage information corresponding to the occurrence of a backlash event for the fishing reel 1B stored in the estimated usage information storage unit 631. In this case, the estimation unit 621 estimates, for example, the drive control parameters that will realize the longest flight distance without generating backlash in accordance with the way in which the user casts, as the optimum conditions.
Step S704: The provision unit 622 transmits the drive control parameters (optimal parameters) estimated as optimal conditions in Step S702 to the user terminal 500.

The automatic parameter setting can also be applied when the fishing reel 1A is provided as an electric reel, as in the above-described first and second embodiments.

As an example, in the first or second embodiment, the water depth (one example of optimum reel conditions) estimated by the fishing-related support server 600 can be set by the fishing reel 1A as an optimal parameter to cause fish to hit. For example, the fishing reel 1A can measure the water depth of the lure in response to the lure being placed in the water and notify the user by display, sound, vibration, etc., when the measured water depth has reached the water depth set as an optimum parameter.

### Fifth Embodiment

The fifth embodiment will now be described. In the fishing information processing system according to the present embodiment, a spinning reel is used as the fishing reel.

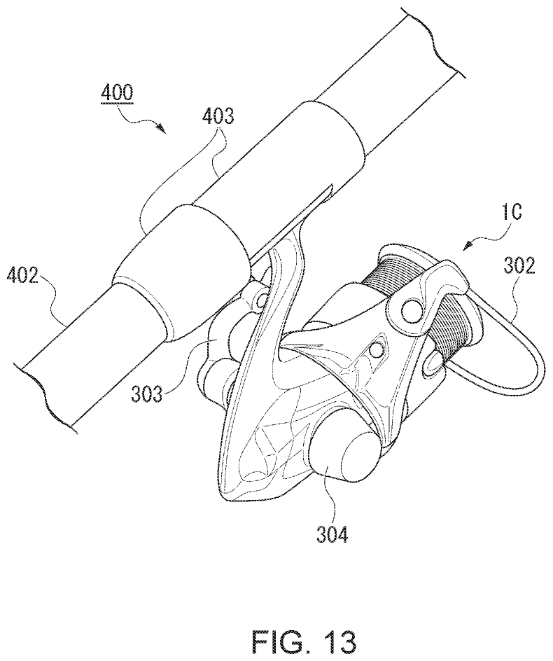

FIG. 13 shows an example of the external appearance of a fishing reel 1C as a spinning reel used in the fishing information processing system of the present embodiment. In the drawing, the fishing reel 1C as the spinning reel is shown attached to a reel mounting base (reel seat) 403 disposed on a rod main body 402 of the fishing rod 400.

Although not shown, sensors are also provided at prescribed positions of the fishing reel 1C as a spinning reel. Examples of sensors installed in the fishing reel 1C include a sensor for detecting the state of rotation (direction of rotation, rotation speed) of the spool 301, a sensor for detecting the opening and closing of a bail arm 302, a sensor for detecting the state of operation (rotation speed) of a handle 303, a sensor for detecting positional changes in the fishing reel 1C itself, and a sensor for detecting vibration of the fishing reel 1C.

As an example of the functional configuration of the fishing reel 1C, the parts corresponding to the function of braking the rotation of the spool, such as the braking unit 2221 and the braking controller 2231, can be omitted from the configuration of FIG. 11. The part serving as the circuit unit part according to the present embodiment can be provided so as to be housed in a handle cap 304, for example.

In the same manner as the fishing reel 1A, 1B of each of the embodiments described above, the fishing reel 1C as a spinning reel configured in this way can store accumulated information including reel information, rod information, and fishing trip-related information, in accordance with the user's actual fishing. In this case, the fishing reel 1C can be made to store the accumulated information to indicate divisions in casting units, in accordance with the opening and closing of the bail arm 302, for example. Further, the fishing reel 1C can store event information in response to the determination of the occurrence of an event, such as a fish hit.

Thus, even in the fishing information processing system of the present embodiment including the fishing reel 1C as a spinning reel, the fishing-related support server 600 can estimate the optimum conditions corresponding to a fish hit, etc., and the estimated optimum conditions can be output with the user terminal 500, in the same manner as in each of the embodiments described above.

### Sixth Embodiment

The sixth embodiment will now be described. In the present embodiment, a configuration (event information processing function unit)corresponding to the sensor unit 101 shown in FIG. 4 (which can be the fishing rod sensor unit 401), the controller 104 (acquisition unit 141, accumulated information storage control unit 142, determination unit 143, event information storage control unit 144, event information transmission unit 146), the storage unit 105 (accumulated information storage unit 151, event information storage unit 152), the communication unit 106, and the like, is provided on the fishing rod.

In this case, the fishing reel (1A, 1B, 1C) need not have functions as the controller 104 and the storage unit 105. That is, the fishing reel (1A, 1B, 1C) need not store and output event information or accumulate accumulated information. The fishing reel 1A can transmit the acquired reel information to the event information processing function unit of the fishing rod.

The event information processing function unit of the fishing rod stores the accumulated information including the rod information, the transmitted reel information, and the fishing trip-related information transmitted from the user terminal 500. The event information processing function unit of the fishing rod determines to occurred of an event, such as a fish hit, and stores the corresponding event information in response to the determination of the occurrence of an event. The event information processing function unit of the fishing rod transmits the event information to the user terminal 500.

Thus, even in the fishing information processing system of the present embodiment including the event information processing function unit, the fishing-related support server 600 can estimate the optimum conditions corresponding to a fish hit, etc., and the estimated optimum conditions can be output with the user terminal 500, in the same manner as in each of the embodiments described above.

### MODIFIED EXAMPLES

Modified examples of each of the above-described embodiments will now be described.

### First Modified Example

In each of the above-described embodiments, the fishing-related support server 600 is communicatively connected to the user terminal 500 via a network. However, it can be anticipated that a network connection may not be available at the location of a fishing trip. In particular, it may be difficult to connect to a network when fishing offshore by boat or from a rocky shore far from the coast.

Thus, for example, a device (fishing-related support device) corresponding to the fishing-related support server 600 of the embodiments described above can be installed on a vessel, at a managed fishing spot, or at facilities near a fishing spot, and the fishing-related support device and the user terminal 500 can then be connected by Wi-Fi (registered trademark), Bluetooth (registered trademark), or other means. Alternatively, the functions of the fishing-related support server 600 of the above-described embodiments can be shared between the fishing-related support device and the user terminal 500. In this case, the functions provided to the user terminal 500 can be downloaded to and implemented on the user terminal 500 in advance.

### Second Modified Example

In the embodiments described above, the estimation unit 621 uses the estimated usage information to estimate optimum conditions. The estimated usage information includes event information extracted from the accumulated information. Therefore, the estimated usage information is information obtained based on the accumulated information, and the estimation unit 621 is understood to estimate the optimum conditions based on the accumulated information.

In the embodiments described above, the estimation unit 621 can be configured to be capable of estimating the optimum conditions using the accumulated information directly.

### Third Modified Example

In each of the second to the sixth embodiments, the fishing reel (1A, 1B, 1C) can be operated to call up and display the contents of the event information stored in the past, as in the first embodiment.

### Fourth Modified Example

In the embodiments described above, for example, the estimation unit 621 can use the fishing trip-related information included in the estimated usage information to estimate, for example, the optimum conditions for a fishing trip (optimum fishing trip conditions), which can be output at the user terminal 500.

As a specific example, the user performs an operation on the user terminal 500 to request optimum fishing trip conditions, specifying a range of areas that the user is considering as fishing trip destinations. The user terminal 500 transmits the optimum fishing trip conditions request including information indicating the specified range of areas to the fishing-related support server 600.

The estimation unit 621 of the fishing-related support server 600 estimates the conditions (optimum fishing trip conditions) considered optimal for fishing trips, in accordance with the range of areas indicated in the received optimum fishing trip conditions request. In this case, the estimation unit 621 can use weather information as well as fishing trip-related information as information included in the estimated usage information. Once the optimal for fishing trips are estimated by including weather conditions, the estimation unit 621 can compare the estimated weather information with weather forecast information to estimate a future date and time suitable for fishing trips and include this estimation in the optimum fishing trip conditions.

The optimum fishing trip conditions obtained in this manner can indicate the timing (date, time, etc.) considered optimal for a fishing trip, locations considered optimal for actual fishing within the specified area, etc. The provision unit 622 transmits the optimum fishing trip conditions obtained in this manner to the user terminal 500 that is the transmission source of the optimum fishing trip conditions request. The user outputs the received optimum fishing trip conditions at the user terminal 500.

### Fifth Modified Example

In the embodiments described above, the optimum information estimated for one user can be shared with other users. Specifically, for example, the provision unit 622 of the fishing-related support server 600 can transmit the optimum information to the other users’ user terminals in response to requests for optimum conditions from the other users' user terminals.

Further, in the embodiments described above, as an example of sharing optimum conditions, the optimal parameters provided to a user can be made available to another user to set in their own fishing reels. In this case, for example, another user can allow their user terminal 500 to access an optimal parameter download site on the fishing-related support server 600 to download the necessary optimal parameters from the download site. The other user can transmit the optimal parameters downloaded to their user terminal to the fishing reel via communication, thereby setting the optimal parameters in the fishing reel.

Further, the event information (one example of information based on accumulated information) stored in the event information storage unit and the accumulated information stored in the accumulated information storage unit in the fishing reel of one user can also be configured to be stored on the fishing-related support server 600. The user terminals of other users can then acquire the event information and accumulated information stored on the fishing-related support server 600.

### Sixth Modified Example

The determination unit (143, 2233d) can determine each of a plurality of different types of events. In this case, the event information transmission unit (146, 2233f) can display or transmit the event information of a type specified by a user operation, for example, from the stored event information.

Thus, the estimation unit 621 of the fishing-related support server 600 can be configured to be capable of estimating one or more types of optimum conditions corresponding to each type of event. In this case, when the user causes the user terminal 500 to output the optimum conditions, the user can operate the user terminal 500 to specify the type of the optimum conditions to be output by the user terminal 500.

### Seventh Modified Example

In each of the embodiments described above, the accumulated information includes at least reel information, and, in addition to the reel information, rod information and/or fishing trip-related information. However, the accumulated information can include at least the rod information and reel information and/or fishing trip-related information. Alternatively, the accumulated information can include at least fishing trip-related information and reel information and/or rod information.

### Eighth Modified Example

In addition to event information, the fishing reel (1A, 1B, 1C) can output the accumulated information stored in the accumulated information storage unit (151, 2234b) by display on the display unit 103 or transmission to the user terminal 500. Further, the fishing reel (1A, 1B, 1C) can be configured to be capable of outputting accumulated information without outputting event information.

The above-described processes as the fishing reel (1A, 1B, 1C), the fishing rod sensor unit 401, the user terminal 500, and the event information processing function unit, etc., can be performed by storing a program for realizing the above-described functions as the fishing reel (1A, 1B, 1C), the fishing rod sensor unit 401, the user terminal 500, and the event information processing function unit, etc., in a computer-readable storage medium, and having a computer system read and execute the program that is stored on this storage medium. Here, “having a computer system read and execute the program that is stored on this storage medium” includes the installation of the program in the computer system. The “computer system” here includes the OS and hardware such as peripheral devices. Further, the “computer system” can also include a plurality of computer devices that are connected via a network, including the Internet and communication lines such as WAN, LAN, and dedicated lines. Further, the “computer-readable storage medium” refers to storage devices such as portable media such as flexible discs, magneto-optical discs, ROM, CD-ROM, HDD, etc., that are incorporated in the computer system. In this manner, the storage medium that stores the program can be a non-transitory storage medium, such as a CD-ROM. Further, the storage medium includes an internally or externally provided storage medium that can be accessed from a distribution server in order to distribute the aforementioned program. The program code that is stored on the storage medium of the distribution server can differ from the program code that is in a form executable by the terminal device. That is, as long as the program can be downloaded from the distribution server and installed in a form executable by the terminal device, the form in which the program is stored in the distribution server is not limited. The program can be divided into a plurality of modules and merged on the terminal device after downloading at different timings, or the distribution server that distributes each of the divided programs can be different. Moreover, the “computer-readable storage medium” shall also include media that retains the program for a set period of time, such as volatile memory (RAM) in the computer system which acts as the server or the client when the program is transmitted via the network. Further, the above-described program can realize some of the above-described functions. Moreover, it can be a program that can realize the above-described functions in combination with a program already stored in the computer system, i.e., a so-called difference file (difference program).

What is claimed is:

1. A fishing information processing system, comprising:
an acquisition unit configured to acquire prescribed fishing information;
a controller configured to cause a storage unit to accumulate the prescribed information acquired by the acquisition unit as accumulated information;
an estimation unit configured to estimate optimum fishing conditions based on the accumulated information accumulated by the controller; and
a provision unit configured to provide the optimum fishing conditions estimated by the estimation unit to a user.

2. The fishing information processing system according to claim 1, further comprising
a determination unit configured to determine an event occurred based on the accumulated information accumulated by the controller, and
a storage control unit configured to cause a storage unit to store the accumulated information corresponding to the occurrence of the event determined by the determination unit as event information,
the estimation unit is configured to update the optimum fishing conditions based on the event information stored in the storage unit.

3. The fishing information processing system according to claim 1, wherein
the provision unit is configured to provide the optimum fishing conditions or the accumulated information based on the accumulated information to devices corresponding to other users.

4. The fishing information processing system according to claim 1, wherein
the accumulated information is reel information related to a fishing reel.

5. The fishing information processing system according to claim 4, wherein
the estimation unit is configured to estimate optimum reel conditions based on the reel information.

6. The fishing information processing system according to claim 5, further comprising
a setting unit configured to set prescribed parameters set in the fishing reel based on at least the optimum reel conditions.

7. The fishing information processing system according to claim 5, wherein
the estimation unit is configured to update the optimum reel conditions based on the accumulated information.

8. The fishing information processing system according to claim 1, wherein
the accumulated information is rod information related to a fishing rod.

9. The fishing information processing system according to claim 8, wherein
the estimation unit is configured to estimate optimum rod conditions based on the rod information,

10. The fishing information processing system according to claim 9, wherein
the estimation unit is configured to update the optimum fishing rod conditions based on the accumulated information.

11. The fishing information processing system according to claim 1, wherein
the accumulated information is fishing trip-related information related to a fishing trip.

12. The fishing information processing system according to claim 11, wherein
the estimation unit is configured to estimate, based on the fishing trip-related information, optimum fishing trip conditions related to the fishing trip.

13. The fishing information processing system according to claim 12, wherein
the estimation unit is configured to update the optimum fishing trip conditions based on the accumulated information.

14. A fishing reel comprising:
the fishing information processing system according to claim 1.

15. A fishing rod comprising:
the fishing information processing system according to claim 1.

16. A fishing information processing program that causes a computer to function as the fishing information processing system according to claim 1.

17. A fishing information processing system, comprising:
an information acquisition for acquiring prescribed fishing information;
an information accumulation control means for causing a storage unit to accumulate the prescribed information acquired by the information acquisition means as accumulated information;
an optimum conditions estimation means for estimating optimum fishing conditions based on the accumulated information accumulated by the information accumulation control means; and
a provision means for providing the optimum fishing conditions estimated by the optimum conditions estimation means to a user.

18. The fishing information processing system according to claim 1, further comprising
a determination means for determining an event occurred based on the accumulated information accumulated by the information accumulation control means, and
a storage control means for causing a storage unit to store the accumulated information corresponding to the occurrence of the event determined by the determination means as event information,
the optimum conditions estimation means for updating the optimum fishing conditions based on the event information stored in the storage unit.
